(19) United States
(12) Patent Application Publication
(10) Pub. No.: US 2003/0039801 A1
(43) Pub. Date: Feb. 27, 2003

(54) Method and apparatus for transporting materials

(76) Inventor: Howard J. Trickett, Hartville, OH (US)

Correspondence Address: John M. Skeriotis, 4421 Ranchwood Spur, Akron, OH, 44333-1343, US

(21) Appl. No.: 10/267,934

(22) Filed: Oct. 9, 2002

Related U.S. Application Data
(62) Division of application No. 09/526,014, filed on Mar. 15, 2000, now abandoned.
(60) Provisional application No. 60/124,392, filed on Mar. 15, 1999.

(51) Int. Cl. B32B 7/00

(52) U.S. Cl. 428/119

(57) ABSTRACT

A method and apparatus for transporting a load from a first location to a second location. A load material is placed within a pallet assembly atop a slip sheet having a first configuration. Upon compression of the load material, the slip sheet assumes a second advantageous configuration wherein the corners and edges of the slip sheet curl slightly upwardly and inwardly toward the load. This configuration allows the insertion of a platen of a conventional fork lift beneath the slip sheet to allow transport of the load without the need for a push/pull attachment on the fork lift.

### BACKGROUND OF THE INVENTION

This application claims the benefit of U.S. Provisional Application Serial No. 60/124,392 filed on Mar. 15, 1999, in Express Mail Label No. EL287032614US by the same inventor, Howard J. Trickett, entitled METHOD AND APPARATUS FOR TRANSPORTING MATERIALS.

1. Field of Invention

This invention pertains to a method of transporting goods, particularly rubber, in a safe, economic and environmentally-sound manner. More particularly, the present invention relates to a method of transporting rubber that eliminates the previous need for wooden crates or pallets during transit.

2. Description of the Related Art

Due to the geographic distance between the bulk of the world's natural rubber production areas and the majority of the users of natural rubber, use of large scale transport methods are necessary to connect the suppliers with the users.

The natural rubber may be initially processed into TSR Crumb and subsequently packed into bales weighing about 70 to 80 pounds each. These bales would typically be packaged in wood crates for shipment. However, there are many concerns and problems that arise when wooden structures are used in the transportation of the rubber. Dead shipping weight, insect infestation, and environmental issues are just a few of the problems currently encountered in the art.

One alternative to the use of crates is the use of palletized loads. Much of the wood content can be reduced by wrapping the rubber in shrink-wrap and transporting the rubber with an associated wooden pallet. However, rubber in particular is highly sensitive to compression forces. Therefore, both the height of the load on the individual pallet and the ability to stack the pallets one upon the other has heretofore been negatively influenced by the tendency of the rubber to fuse and flow from the pressure.

In an effort to overcome the disadvantages of utilizing wooden crates or pallets during transit U.S. Pat. No. 5,613,447 discloses a transport unit for natural rubber which includes a polymeric slip sheet, a plurality of individual rectangular solid bales formed of natural rubber, stacked upon the slip sheet so as to form a rectangular solid unit, and at least one layer of a stretchable polymeric film wrapped around the sides and top of the rectangular solid unit to hold the unit together. The advantages of this transport unit is the use of previously-processed polymer for the slip sheet that is not susceptible to insect infestation. In addition, the weight of the non-rubber materials used in each of the transport units comprises less than about ½ of 1% percent of the total weight.

To assist in subsequent transporting operations, the slip sheet includes compressible tabs which extend outwardly from at least one side to enable a lifting device to grip and move the transport units. In order to effectively utilize slip sheets of this type, the lifting device must be modified from the conventional fork lift and include gripping means in what is commonly referred to as a push/pull attachment.

The present invention provides a method and apparatus for transporting materials, especially rubber, that eliminates the need to ship wooden crates or pallets, eliminates the need to provide gripping areas on the slip sheet and utilizes a conventional forklift rather than a push/pull arrangement in order to overcome the foregoing difficulties and others while providing better and more advantageous overall results.

### SUMMARY OF THE INVENTION

In accordance with the present invention, there is provided a method for preparing and transporting a load of compressible material. The method comprises the steps of providing a pallet assembly including a pallet member having a generally planar supporting surface and a rigid forming member including four upright walls wherein the forming member defines a generally rectangular cross-sectional area, the forming member being selectively positioned above the planar supporting surface; providing a sheet within the confines of the forming member adjacent the supporting surface of the pallet member, the sheet being able to re-form from a first, unloaded configuration to a second, loaded configuration upon a loading thereof, wherein the first, non-loaded configuration is characterized by a generally planar, rectangular load supporting surface and four upturned sides positioned adjacent the perimeter of the load supporting surface, the load supporting surface and the upturned sides defining four corners; placing a load of compressible material onto the load supporting surface of the sheet; utilizing compressing means for a sufficient period of time in order to compress the load and cause the sheet to assume the second, loaded configuration wherein the corners and the sides are slightly curled upwardly and inwardly toward the load; and, removing the forming means.

According to another aspect of the invention, the method 1 further comprises the step of utilizing means for maintaining the second configuration of the sheet after the step of removing the forming means.

According to another aspect of the invention, the sheet comprises polymeric material.

According to another aspect of the invention, the forming member is metallic.

According to another aspect of the invention, the compressing means are utilized between 4 and 72 hours, inclusive.

According to another aspect of the invention, the second configuration of the sheet is maintained by wrapping the upturned sides of the sheet and the load with a binding material.

According to another aspect of the invention, there is provided a supporting sheet for use in transporting material. The sheet comprises a first, non-loaded configuration characterized by a generally planar, rectangular load supporting surface and four upturned sides positioned adjacent the perimeter of the load supporting surface, the load supporting surface and the upturned sides defining four corners; and, a second, loaded configuration wherein each corner and the sides are curled upwardly and inwardly.

According to another aspect of the invention, the sheet comprises previously-processed polymeric material.

According to another aspect of the invention, there is provided a system for packaging an associated load of compressible material comprising a pallet assembly including a pallet member having a generally planar supporting surface and a rigid forming member including four upright walls wherein the forming member defines a generally rectangular cross-sectional area, the forming member being selectively positioned above the planar supporting surface; a sheet selectively positioned within the confines of the forming member adjacent the supporting surface of the pallet member, the sheet being able to re-form from a first, unloaded configuration to a second, loaded configuration upon a loading thereof, wherein the first, non-loaded configuration is characterized by a generally planar, rectangular load supporting surface and four upturned sides positioned adjacent the perimeter of the load supporting surface, the load supporting surface and the upturned sides defining four corners; and, compressing means adapted for compression of the associated load upon positioning the load onto the load supporting surface, the compressing means being able to cause the sheet to assume the second, loaded configuration wherein the corners and the sides are slightly curled upwardly and inwardly toward the associated load.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a side view, partly in section, of a prior art slip pallet with a grip tab being acted upon by a lifting device equipped with a gripping mechanism;

FIG. 2 is an exploded perspective view of a pallet assembly according to the invention;

FIG. 3 is a front view, partly in section of a loaded pallet assembly according to the invention; and,

FIG. 4 is a front view of an integral unit of load material and a slip sheet according to the invention.

### DESCRIPTION OF THE PREFERRED EMBODIMENT

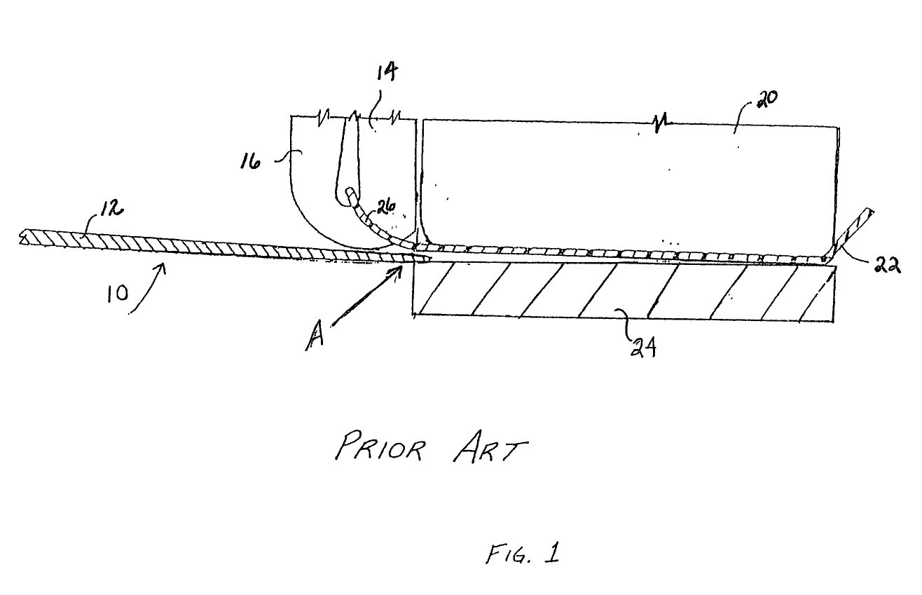

Referring now to the drawings wherein the showings are for purposes of illustrating a preferred embodiment of the invention only and not for purposes of limiting the same, FIG. 1 shows a partial side sectional view of a lifting apparatus 10 having a platen 12, an abutment wall 14, and a gripping mechanism 16. This type of lifting apparatus is well known in the art. In this case, a conventional forklift is modified by a push/pull attachment which includes the gripping mechanism 16. Also shown in FIG. 1 is a load 20 positioned on a prior art slip pallet 22. This particular slip pallet 22 includes a grip tab 26 which extends outwardly from the load 20 so that the gripping mechanism 16 can orient the lower edge of the slip pallet 22 to allow the platen 12 to slide beneath the slip pallet 22 and lift the load 20. Although this prior art design presents disadvantages, it should be noted that at the point of insertion of the platen 12 (denoted by Arrow A), the slip pallet 20 is advantageously curved upwardly and slightly toward the load 20 by the action of the gripping mechanism 16 on the grip tab 26.

In the present invention, the advantageous orientation of a slip sheet at the point of insertion of a platen is achieved without the use of grip tabs or a push/pull attachment having a gripping mechanism.

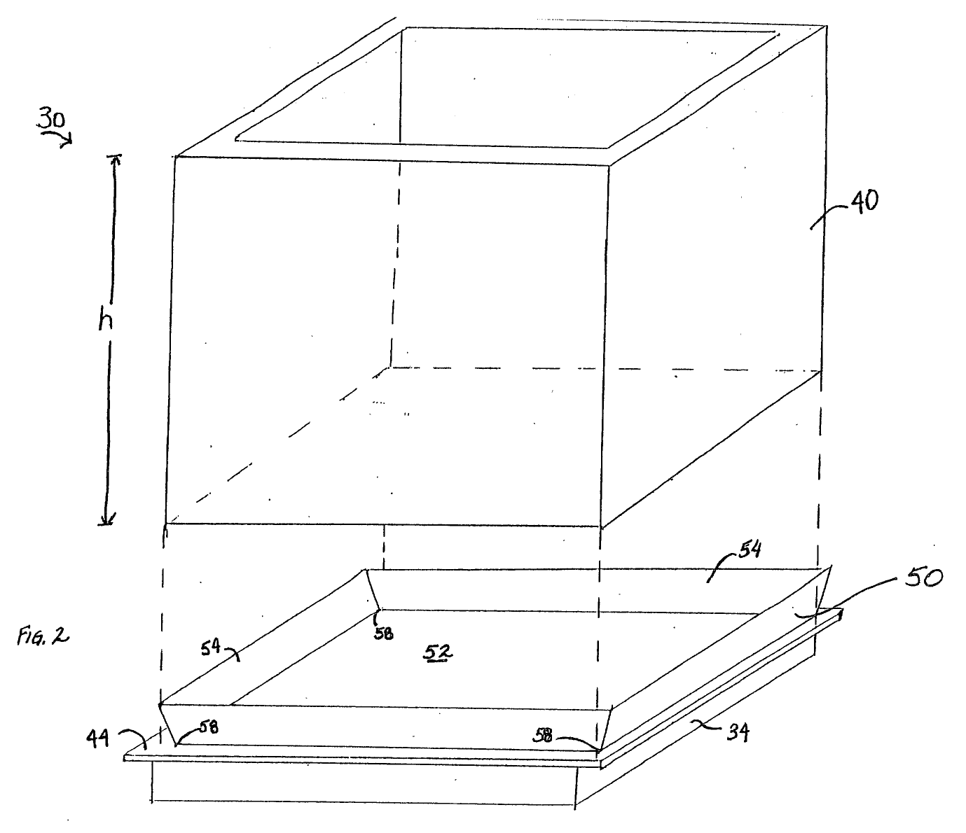

In the present invention, a method is provided for preparing and transporting a load utilizing a slip sheet. With reference to FIG. 2, an exploded view of an unloaded pallet assembly 30 is shown. A conventional pallet 34 serves as a base for the pallet assembly 30. The pallet 34 may be made of metal, wood or other material well known in the art. Although a flat or slotted pallet 34 is utilized in the practice of the present invention, it will become readily apparent that this pallet 34 is not shipped or transported along with a load, but is used at the loading site and remains behind when the load is shipped. The pallet 34 is therefor referred to as a “captive pallet”. In a preferred embodiment of the invention, a metal pallet is used due to a longer life span and resistance to damage as compared to wooden pallets. The owner of the captive pallet may be willing to invest more money in a captive pallet because it does not leave the loading site when the load is transported.

The pallet assembly 34 also includes a forming member 40 selectively positioned on the horizontal surface 44 of the pallet 34. The forming member 40 preferably includes four upright walls each having a predetermined height, h, but no base and no cover. The forming member 40 defines a cross-sectional area that is generally rectangular in shape.

Further in the practice of the present invention, a slip sheet 50 is placed within the confines of the forming member 40 adjacent the upper horizontal surface 44 of the captive pallet. The preferred slip sheet 50 of the present invention includes a generally rectangular load supporting surface 52 and four turned up sides 54. Also in the preferred embodiment, the slip sheet 50 is formed of material that is able to change configurations when acted upon by compression forces. The material may be cardboard or new or recycled or a combination polymeric material. The slip sheet 50 shown in FIG. 2 has an initial, unloaded configuration wherein the corners 58 of the load supporting surface 52 generally lie in the plane defined by the horizontal surface 44 of the pallet 34. In the preferred embodiment of the invention, the slip sheet 50 is positioned onto pallet 34 after the forming member 40 is itself positioned on the captive pallet 34 so that the turned up sides 54 are entirely confined within the area bounded by the forming member 40. In the preferred embodiment, the shape of the load supporting surface 52 of the slip sheet 50 conforms generally to the rectangular shape defined by the forming member 40.

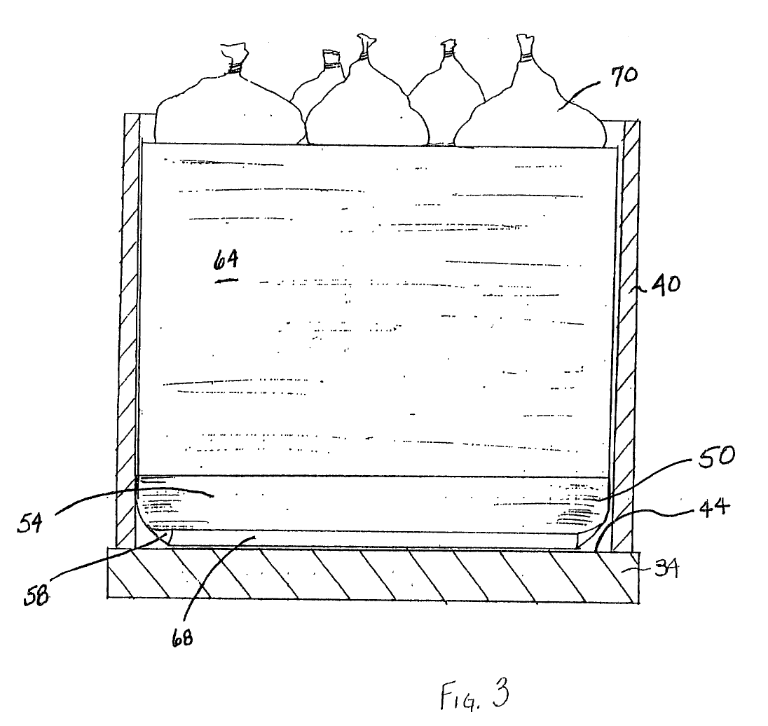

With respect to FIG. 3, the load material 64 is then introduced into the interior of the forming member 40 and onto the load supporting surface 52 of the slip sheet 50. The present invention is particularly suitable for utilizing load material 64 of natural or synthetic rubber because of the heretofore “disadvantageous” qualities inherent in the material. As discussed earlier in this disclosure, in the art of loading and transporting rubber, the susceptibility of rubber to compression forces has produced problems in the loading and transport of rubber material. However, the present invention takes advantage of the tendency of the rubber material to flow and fuse under pressure in an unusual and unexpected manner.

The load material 64 is then intentionally compressed for a predetermined time by using compressing means 70 such as weights placed atop the load material 64. In the preferred embodiment, weights are used as the compressing means 70 and are positioned for between 4 and 72 hours. The compressing time must be sufficient to cause the load material 64 to compress and cause the slip sheet 50 to assume a second, loaded configuration. In the compressed configuration, the corners 58 and edges 68 of the load supporting surface 52 are curled slightly upwardly away from the horizontal surface 44 of the pallet 34 and toward the load material 64.

A comparison of FIG. 3 with FIG. 1 shows the similarity between the configuration of the prior art slip pallet 22 when the grip tab 26 is acted on by the gripping mechanism 16 and the compressed configuration of the slip sheet 50 of the present invention. One advantage of the present invention is that the desired configuration does not require the slip sheet 50 to include any gripping tabs and therefore an associated gripping means is not necessary on the lifting vehicle. The present invention therefore allows use of a conventional fork lift rather than one modified by a push/pull attachment.

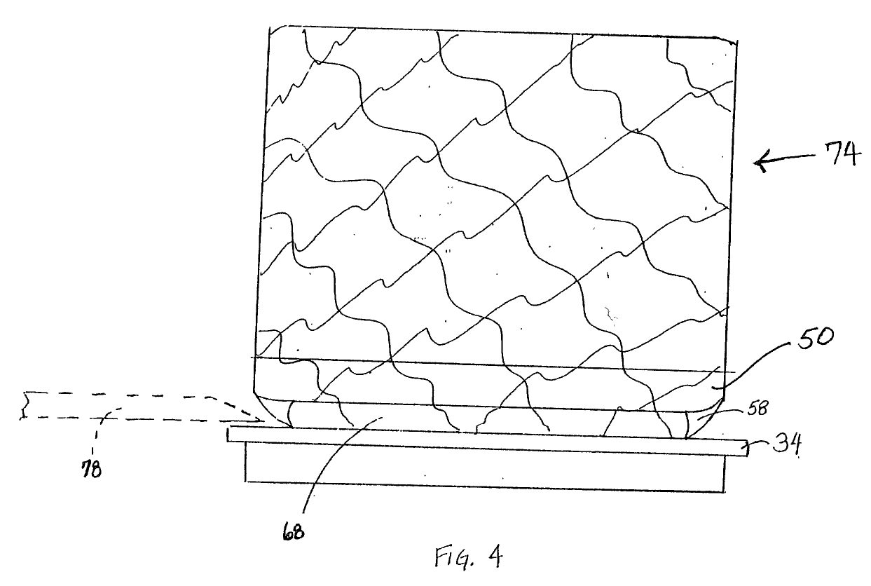

After the load material 64 is compressed, the compressing means 70 are removed. The forming member 40 is removed from the captive pallet 34 leaving behind the compressed load material 64 atop the slip sheet 54 which exhibits the desired configuration. In the preferred embodiment of the invention, the compressed load material 64 and slip sheet 50 are then wrapped in a shrink wrap material or banded by any means known in the art to form an integral unit 74, as shown in FIG. 4. At this point, for ease of movement, any local movement of the integral unit 74 can be done utilizing a conventional fork lift with the captive pallet 34 still positioned beneath the integral unit 74.

The integral unit 74 is then ready to be shipped from the supplier to the receiver. At this point, the integral unit 74 is loaded into a shipping container (not shown) by utilizing a lifting device which may be a conventional fork lift (also not shown). A platen 78 (shown in dashed lines) of an associated lifting device may be readily slipped beneath the slip sheet 50 in order to load only the integral unit 74 into the shipping container, leaving behind the captive pallet 34. Because the slip sheet 50 embodies the second configuration, that is, it exhibits a upward and inward curl at the edges 68 and corners 58 of the load supporting surface 52, the platen 78 is able to slip beneath the integral unit 74 without the use of gripping tabs or a gripping mechanism. When the integral unit 74 is loaded into the shipping container, the captive pallet 34 remains at the loading site.

At the receiving end of this process, a lifting device may be utilized to place the integral unit 74 onto a subsequent pallet for future movement and storage using methods known in the art.

Although the invention has been described with reference to natural and synthetic rubber load materials 64, it is anticipated that other load materials may be utilized in the practice of the present invention. The invention may be practiced with any material that causes the advantageous configuration of the loaded slip sheet 50.

The invention has been described with reference to the preferred embodiment. Obviously, modifications and alterations will occur to others upon a reading and understanding of the specification. It is intended by applicant to include all such modifications and alterations insofar as they come within the scope of the appended claims or the equivalents thereof. Having thus described the invention, it is claimed:

What is claimed is:

1. A method for preparing and transporting a load of compressible material, the method comprising the steps of:
providing a pallet assembly including a pallet member having a generally planar supporting surface and a rigid forming member including four upright walls wherein the forming member defines a generally rectangular cross-sectional area, the forming member being selectively positioned above the planar supporting surface;
providing a sheet within the confines of the forming member adjacent the supporting surface of the pallet member, the sheet being able to re-form from a first, unloaded configuration to a second, loaded configuration upon a loading thereof, wherein the first, non-loaded configuration is characterized by a generally planar, rectangular load supporting surface and four upturned sides positioned adjacent the perimeter of the load supporting surface, the load supporting surface and the upturned sides defining four corners;
placing a load of compressible material onto the load supporting surface of the sheet;
utilizing compressing means for a sufficient period of time in order to compress the load and cause the sheet to assume the second, loaded configuration wherein the corners and the sides are slightly curled upwardly and inwardly toward the load; and,
removing the forming means.

2. The method of claim 1 further comprising the step of:
utilizing means for maintaining the second configuration of the sheet after the step of removing the forming means.

3. The method of claim 1 wherein the step of providing a sheet further includes providing a sheet comprising polymeric material.

4. The method of claim 1 wherein the step of providing a pallet assembly further includes providing a metallic forming member.

5. The method of claim 1 wherein the step of utilizing compressing means further includes the step of utilizing the compressing means for between 4 and 72 hours, inclusive.

6. The method of claim 1 wherein the step of utilizing compressing means includes placing a weight on top of the load of compressible material.

7. The method of claim 2 wherein the step of utilizing means for maintaining the second configuration of the sheet includes wrapping the upturned sides of the sheet and the load with a binding material.

8. A supporting sheet for use in transporting material, the sheet comprising:
a first, non-loaded configuration characterized by a generally planar, rectangular load supporting surface and four upturned sides positioned adjacent the perimeter of the load supporting surface, the load supporting surface and the upturned sides defining four corners; and,
a second, loaded configuration wherein each corner and the sides are curled upwardly and inwardly.

9. The supporting sheet of claim 8 comprising polymeric material.

10. The supporting sheet of claim 9 wherein the polymeric material is previously-processed polymeric material.

11. A system for packaging an associated load of compressible material comprising:
a pallet assembly including a pallet member having a generally planar supporting surface and a rigid forming member including four upright walls wherein the forming member defines a generally rectangular cross-sectional area, the forming member being selectively positioned above the planar supporting surface;
a sheet selectively positioned within the confines of the forming member adjacent the supporting surface of the pallet member, the sheet being able to re-form from a first, unloaded configuration to a second, loaded configuration upon a loading thereof, wherein the first, non-loaded configuration is characterized by a generally planar, rectangular load supporting surface and four upturned sides positioned adjacent the perimeter of the load supporting surface, the load supporting surface and the upturned sides defining four corners; and,
compressing means adapted for compression of the associated load upon positioning the load onto the load supporting surface, the compressing means being able to cause the sheet to assume the second, loaded configuration wherein the corners and the sides are slightly curled upwardly and inwardly toward the associated load.

12. The system of claim 11 further comprising:
means for maintaining the second configuration of the sheet.

13. The system of claim 12 wherein the means for maintaining the second configuration of the sheet comprises binding material.
